(19) United States
(12) Patent Application Publication
(10) Pub. No.: US 2021/0312145 A1
(43) Pub. Date: Oct. 7, 2021

(54) PROVISIONING A NOTE BACKED BY CRYPTOCURRENCY

(71) Applicant: Olof Kyros Gustafsson, Dubai (AE)

(72) Inventor: Olof Kyros Gustafsson, Dubai (AE)

(21) Appl. No.: 16/104,865

(22) Filed: Aug. 17, 2018

(51) Int. Cl. G06K 1/12; G06Q 20/06; G06Q 20/38; G06K 19/06; G06K 19/16; G06Q 40/02; B41M 3/14

(52) U.S. Cl. CPC G06K 1/121; G06Q 20/0655; G06Q 20/389; G06K 19/06178; B42D 25/328; G06K 19/16; G06Q 40/02; B41M 3/14; G06K 19/06065

(57) ABSTRACT

A method of provisioning a note for use as currency is provided, including receiving a base material and printing a note from the base material. The note includes a first unique identifier and a second unique identifier. The method further includes covering the second unique identifier with a tamper-proof material and covering a back of the second unique identifier with a tamper-evident material. The method also includes recording a transaction associating the first unique identifier and the second unique identifier with a predetermined amount of cryptocurrency in a recordation facility accessible for validation of the cryptocurrency.

### BACKGROUND

Currency as a form of legal tender for debts permits governments to stabilize and simplify commerce. It also provides a convenient medium of exchange for individuals and businesses. Simply paying cash for a purchase is the easiest way to complete a transaction in most situations.

However, currency has various limitations. For example, counterfeit currency can often be produced at a fraction of the nominal value of the currency. This potentially yields far-reaching effects. Not only is an individual inconvenienced when counterfeit currency ruins a transaction, but follow-on effects come into play as well. Lack of faith in a currency due to counterfeiting can destabilize the markets depending on that currency, and can eventually wreak havoc with government functions overall as the money supply fails to live up to its main purpose.

Thus, it can be useful to provide a form of currency which can be validated. Some responses to this situation involve various indicia of validity incorporated into a bill, such as security strips, watermarks, holographic features and other measures. However, these responses do not provide for third-party validation of currency, only for a check on validity of a bill or note based on physical features. Finding a way to allow for validation based on an authoritative third party can allow for greater confidence in physical currency, while still providing flexibility in transactions.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a process of creating a note.

FIG. 2 illustrates an embodiment of a process of provisioning a note.

FIG. 3 illustrates an alternate embodiment of a process of provisioning a note.

FIG. 4 illustrates an embodiment of a process of transacting with a note.

FIG. 5 illustrates an embodiment of a process of using the value associated with a note.

FIG. 6 illustrates an embodiment of a process of using a note.

FIG. 7 illustrates an embodiment of a network or system which may be used as part of or in association with a system such as that of FIG. 9.

FIG. 8 illustrates an embodiment of a device which may be used as part of a system or network.

FIG. 9 illustrates a system in which a note may be used.

FIG. 10 illustrates an embodiment of a note in a front view.

FIG. 11 illustrates an embodiment of a note in a back view.

### DETAILED DESCRIPTION

A system, method and apparatus is provided for provisioning a note backed by cryptocurrency. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

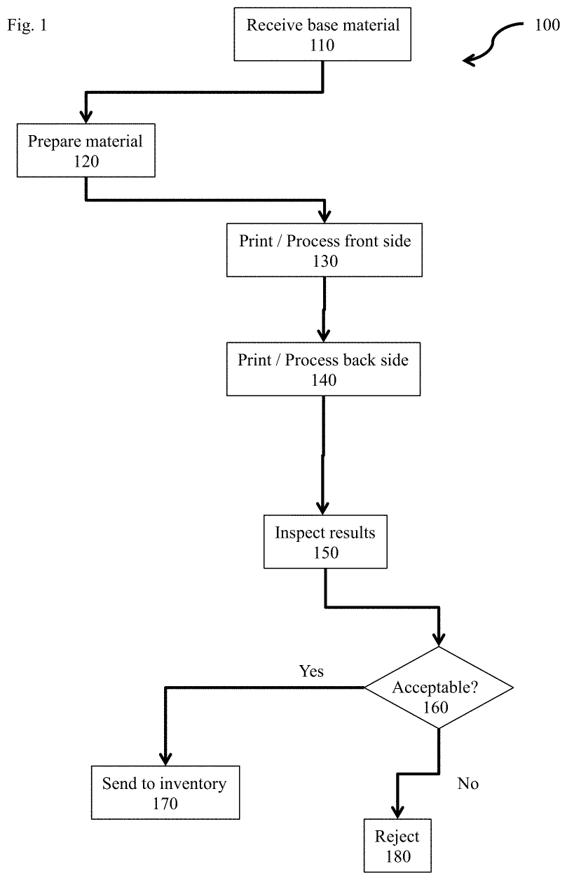

Notes can be created through a variety of processes resulting in a note which has two identifiers, including a first identifier such as a serial number and a second identifier such as a hidden identifier. Providing such a note and recording some form of blockchain transaction involving the two identifiers can provide for a system of commerce which can be authenticated in an effective fashion that may counteract many attempts to tamper with commerce or counterfeit currency. FIG. 1 illustrates an embodiment of a process of creating a note. Process 100, and the other processes described herein, is presented as a set of steps or modules which may potentially be rearranged or reordered, and executed in a stepwise linear fashion, executed in parallel, or in some combination of linear and parallel execution. Process 100 includes receiving and preparing a base material, printing on the material, inspecting results, and accepting or rejecting the resulting note. At module 110, base material for a note is received, such as a cotton or linen sheet or paper. At module 120, the base material is prepared and inspected for suitability, with unacceptable material filtered out. Printing or other processing of a front side or front surface of a note occurs as module 130. This may involve simple offset printing, for example, and may also involve embedding security features, dyeing the base material, holographic printing, or other processes. Thereafter, or in parallel with module 130, printing and processing of the back surface of a note occurs as module 140, and may involve similar printing processes to produce a note of currency. At module 150, results of the process are inspected in the form of potentially finished notes, including inspection of sheets of notes or individual notes or both, for example. A determination of acceptability occurs as module 160, relating to whether the note produced meets currency standards or whether defects in processing occurred. If the note is acceptable, it is sent to inventory at module 170, or it is rejected and generally destroyed at module 180. Generally, a note produced by the process 100 can be expected to provide information about the type of currency, denomination, some indicia indicating authenticity generally, and conformance with other currency requirements.

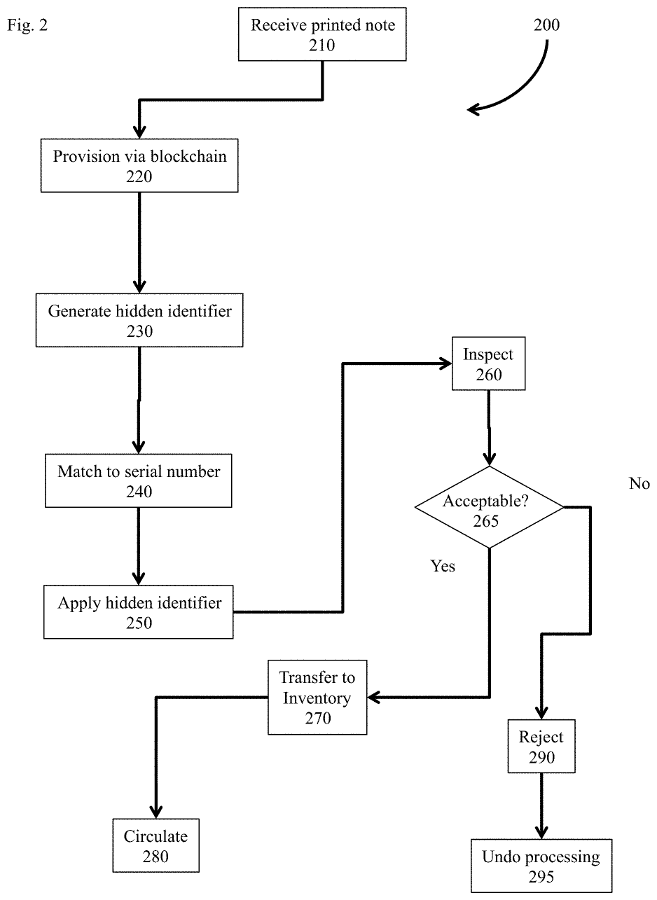

To produce the note with a hidden identifier and blockchain associations, additional processing occurs. FIG. 2 illustrates an embodiment of a process of provisioning a note. Process 200 includes receiving a printed note, provisioning the note with value through a blockchain transaction, generating and placing a hidden identifier and associated material, then inspection and either circulation or cancelling of the provisioning transaction.

At module 210, a note is received. To add value to the note associated with the denomination, the note is provisioned in a blockchain-recorded transaction. Thus, a government may purchase bitcoin or some other cryptocurrency to back up the value of the note and record the transaction in a blockchain associated with the cryptocurrency. Alternatively, other options may be exercised to use a designated blockchain in some embodiments, or to record a transaction related to the note, such as the creation and/or maintenance of its own unique cryptocurrency and associated blockchain, for example. The recorded transaction includes a serial number or first identifier for a note and a second identifier such as a hidden identifier generated at module 230, for example. In some embodiments, the hidden identifier is generated as a result of the blockchain transaction, and may encode identifying information for the blockchain transaction, for example.

The hidden identifier of module 230 is matched to the serial number of the note or bill at module 240, and is applied to the note at module 250. Application may involve adhering a separate layer of material, for example, or printing the hidden identifier on the note, for example, in various embodiments. Moreover, application of the hidden identifier typically involves applying a covering layer above the hidden identifier which is removable in a tamper-evident manner, either by applying a cover layer or by printing or otherwise covering the hidden identifier. A layer which can be scratched off or a layer adhered to the note atop the hidden identifier may be used, for example. Application of the hidden identifier also involves applying a backing layer to the note. The backing layer may be adhered to the note, for example, and may be expected to be opague to visual and non-visual frequencies of electromagnetic radiation, for example, to avoid an attempt to read the hidden identifier without uncovering it. The backing layer may be produced as part of the preparation process for the note in process 100 as well in some embodiments.

With the note provisioned, it is inspected at module 260. If the note is acceptable, this is determined at module 265, and the note is transferred to inventory at module 270 leading to circulation of the note in commerce at module 280. If there is a problem with the note, it is rejected at module 290, and the provisioning process is cancelled, undone, or reversed through a second transaction at module 295, for example, to extract the value of the note as recovery. This may involve cancelling or more likely a second reversing transaction on the blockchain used for provisioning.

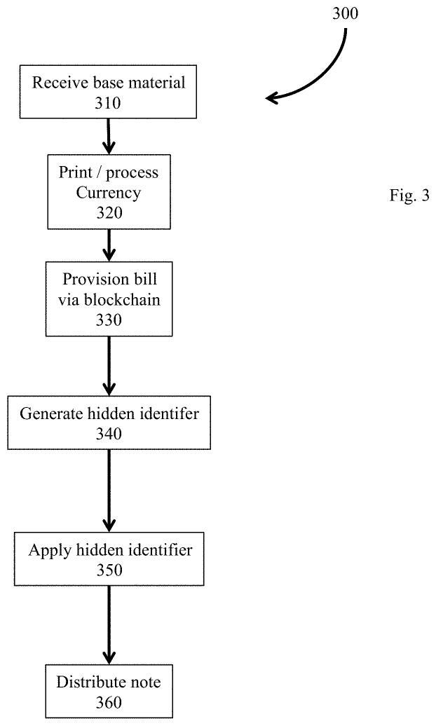

Various processes may be used generally for making a note. FIG. 3 illustrates an embodiment of a process of provisioning a note. Process 300 is presented as a set of steps or modules which may potentially be rearranged or reordered, and executed in a stepwise linear fashion, executed in parallel, or in some combination of linear and parallel execution. Process 300 initiates with module 310 and receipt of base material of a note. At module 320, the note is printed or otherwise processed to form currency, including providing for any standard visual features of the note such as identifying information and security features, for example.

At module 330, the note is provisioned by associating a serial number or first identifier such as serial number 140 of the note with a second identifier such as a hidden identifier of the note. The second identifier is recorded in association with the first identifier in a blockchain system selected as authoritative by an issuer of the note. Thus, the blockchain system may be that associated with bitcoin, for example, or may be a blockchain system otherwise provided for. Recording with the blockchain of bitcoin, for example, may occur through a transaction using bitcoin with the first and second identifiers recorded as part of the transaction. This recording then allows for third-party verification by checking the hidden identifier (second identifier) is properly recorded against the first identifier (e.g. serial number) when one seeks to use the value of the note.

At module 340, a hidden identifier is generated which provides the second identifier which was recorded against the first identifier (e.g. a serial number of the note). At module 350, the hidden identifier is applied to the note such as through printing on the note or applying an adhesive backed material embodying the hidden identifier on the note. Moreover, at module 350, the hidden identifier is further obscured by applying the backing and cover for the hidden identifier. At module 360, the complete note is distributed, such as to a consumer facing bank for circulation.

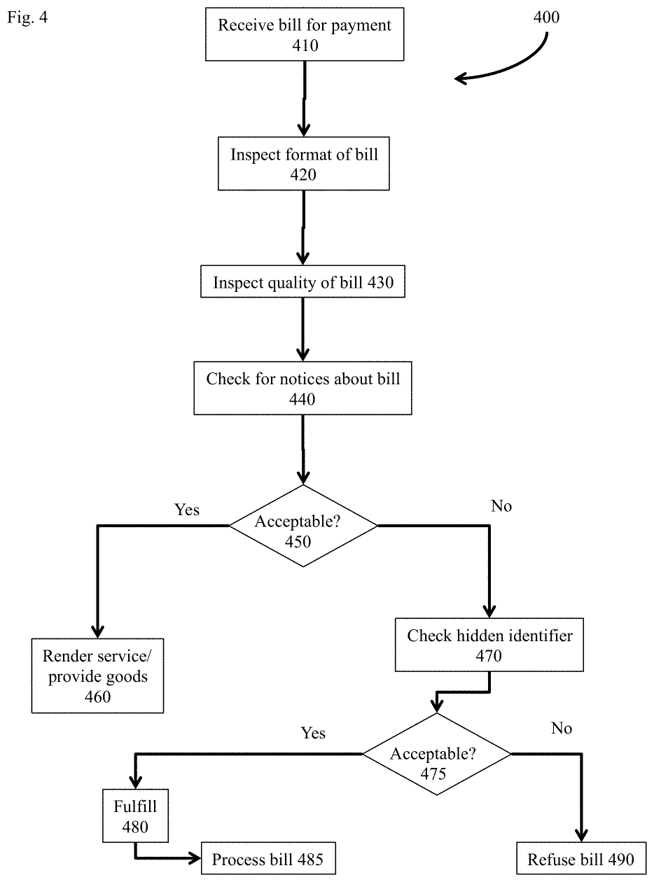

With the note available, circulation commences. FIG. 4 illustrates an embodiment of a process of transacting with a note. Process 400 relates to a typical payment process which may involve using the value of the bill or simply circulating the bill. A bill or note is received for payment at module 410, such as by a bank, merchant or consumer. At module 420, the receiver inspects the bill's format, such as whether proper indicia are present. At module 430, the receiver inspects the quality of the bill, such as whether it is made of apparently correct material. At module 440, the received may further check on any notices about the bill, such as a publicly distributed or publicly accessible list of known counterfeit bills, for example. Based on these inspections of modules 420, 430 and 440, a determination is made as to whether the bill is acceptable at module 450. If yes, the bill is accepted as legal tender, and the receiver renders services, provides goods, or otherwise fulfills any obligations at module 460.

If the bill is not acceptable, at module 470, the receiver may check the hidden identifier. The receiver may also simply refuse the bill at this point (not shown). If the hidden identifier is acceptable as determined at module 475, then at module 480 the receiver may fulfill obligations as at module 460, and may also transfer the value of the bill at module 485. If the hidden identifier is not acceptable, the receiver may refuse the bill at module 490.

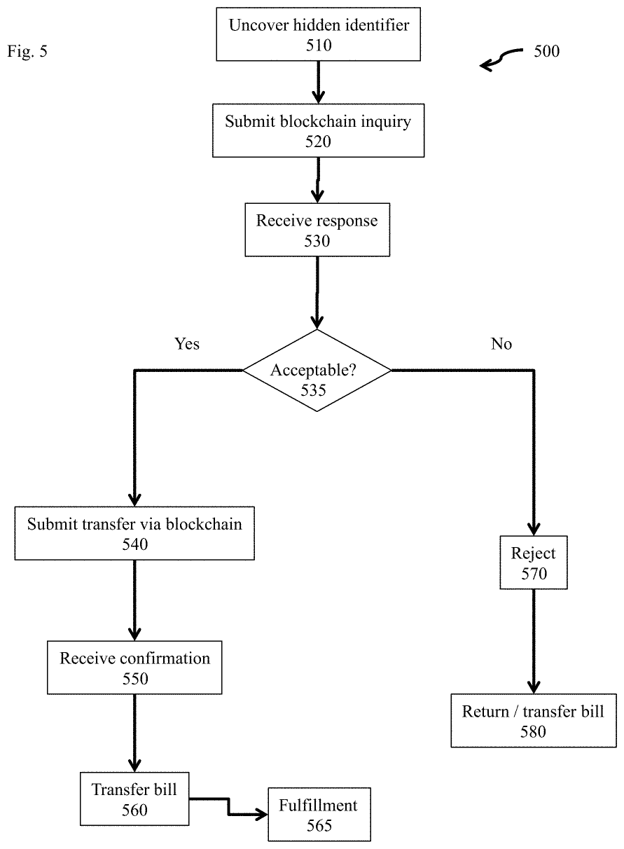

Checking the hidden identifier involves additional aspects. FIG. 5 illustrates an embodiment of a process of using the value associated with a note. At module 510, the hidden identifier is uncovered, revealing the actual hidden identifier. Using the hidden identifier, at module 520, one submits a blockchain inquiry to determine if the hidden identifier and a corresponding first identifier such as a serial number are the basis for a recorded blockchain transaction. One is seeking both a proper initial blockchain transaction, and evidence that no follow-on blockchain transaction transferring the value of the bill has occurred. The inquiry of module 520 results in a response at module 530, indicating whether a first blockchain transaction provisioning the bill occurred, and whether any later blockchain transactions transferred value (some or all) from the bill. At module 535, a determination is made as to whether the bill is proper for the payment it was presented for—it may have only partial value, but that may be enough. If the bill is proper, then at module 540, a transfer transaction is submitted to transfer value from the bill, and one receives confirmation at module 550. The bill is then transferred as payment (and potentially retired) at module 560, and fulfillment occurs at module 565 (such as fulfillment of module 460 or 480). If the bill is not proper, the bill is rejected at module 570 and the bill may be returned or transferred as appropriate to the situation, including retirement as a counterfeit bill if appropriate or some similar result indicating the bill is inappropriate.

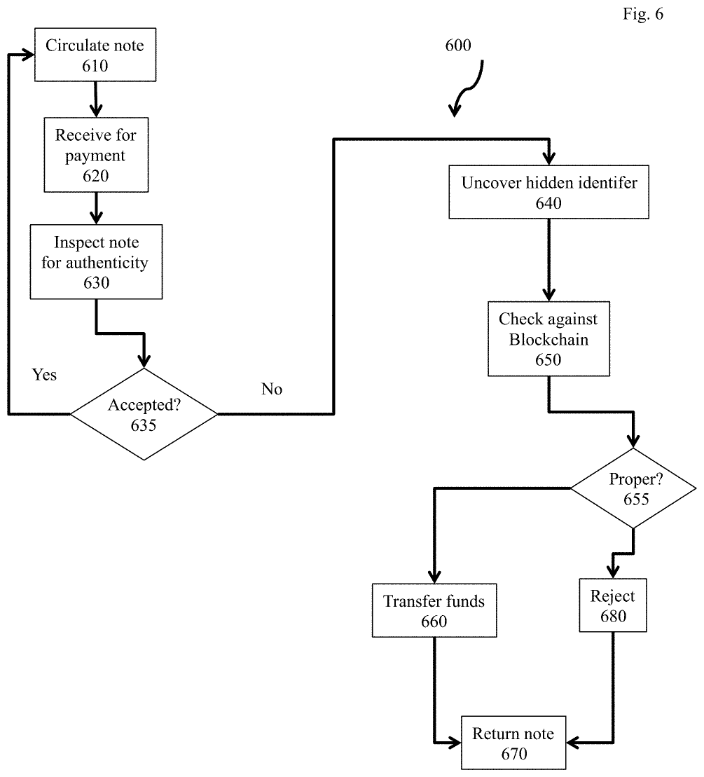

Other processes may also allow for use of the note when it is ready for circulation. FIG. 6 illustrates an embodiment of a process of using a note. Process 600, like process 500, is presented as a set of steps or modules which may potentially be rearranged or reordered, and executed in a stepwise linear fashion, executed in parallel, or in some combination of linear and parallel execution. Process 600 initiates at module 610 with circulation of a note or bill. At module 620, the note is received for payment, such as by a consumer or merchant. At module 630, the note is inspected for authenticity. This may be as simple as checking that the various features of the note appear correct. However, it may also involve special checking of features visible under ultraviolet light or checking of reactivity or lack thereof of the note to a known substance, for example. It may also involve looking up a serial number visible on the note to check for presence on a list of known bad serial numbers or known good serial numbers, for example. Such a list may be publicly accessible from a central bank, for example. If the note or bill is acceptable, this is determined at module 635 based on the check of module 630, and the note may then be circulated further at module 610 in other commerce, for example. Moreover, the note may be part of a transaction where goods are delivered or fulfilled, or services are provided or fulfilled, for example.

If the note is not considered sufficiently authenticated, a choice may be made at module 635 to not simply accept the note, but to check the hidden identifier. For embodiments, where the hidden identifier is tamper-resistant or tamper-proof, this may effectively destroy the value of the note. At module 640, the hidden identifier is uncovered. At module 650, the user checks the hidden identifier against the recorded blockchain transaction for the hidden identifier and serial number, for example. This may involve referencing information provided by an issuing authority such as a central bank, for example. Alternatively, the process may involve searching the ledgers of the blockchain or otherwise querying the blockchain to find the transaction independently. Additionally, the blockchain registration information is checked for any further transactions which transfer the funds associated with the hidden identifier and the serial number. At module 655, results of the check of module 650 are evaluated to determine if the hidden identifier and serial number or first identifier and second identifier were properly recorded in the applicable blockchain and the value is still available (not further transferred). If they were, then at module 660, the funds from the transaction may be transferred through a further transaction on the blockchain, exhausting the funds backing the note. Alternatively, if the initial transaction provisioning the note is not found, or a further transaction exhausting the note is found, then the note may be rejected at module 680 as no longer having any value associated with it. Regardless, once the hidden identifier has been used and the value is either transferred or found to be lacking, at module 670, the note may be returned to a central authority as having had the value of the note transferred and thereby no longer having the same value available for circulation. In some embodiments, users may choose to circulate notes that have value exhausted as well, with the removal of tamper-evident cover showing the status of the note, for example.

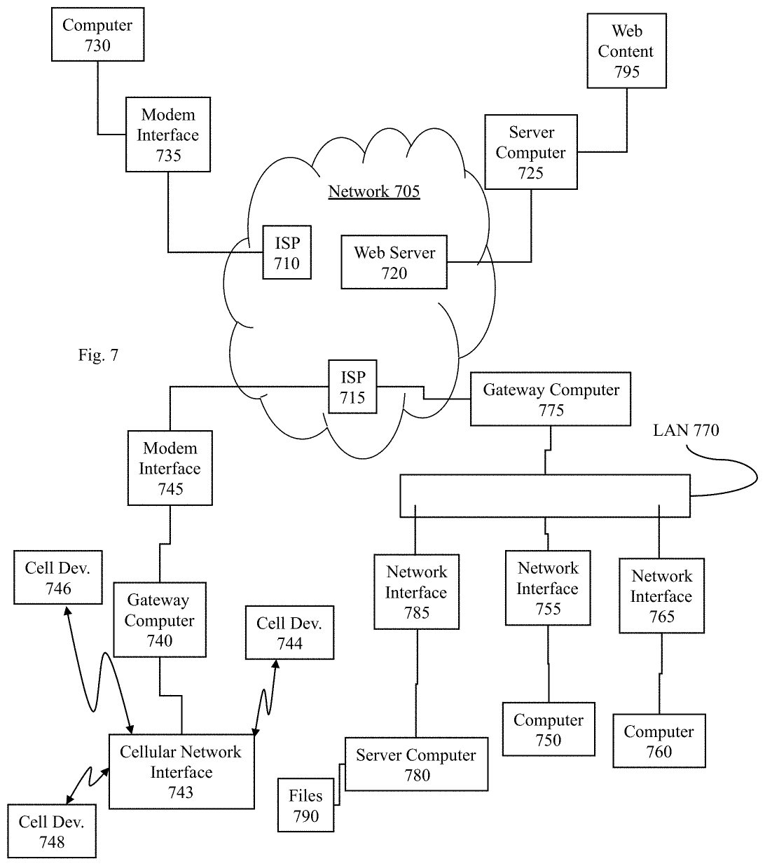

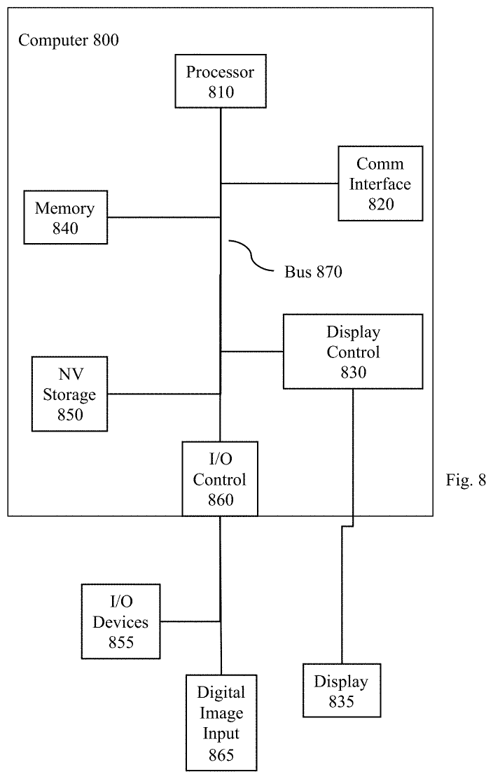

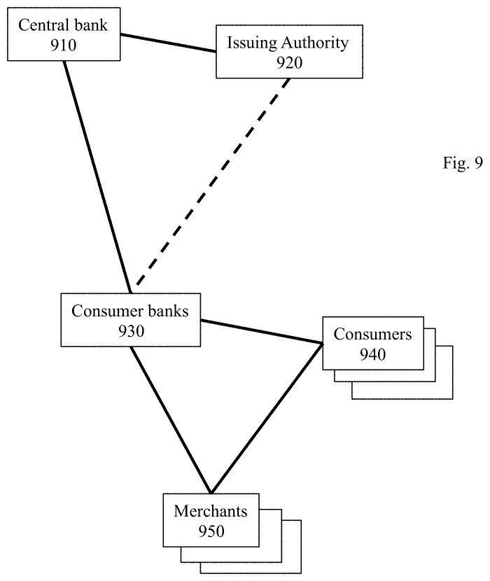

FIG. 7 illustrates an embodiment of a network or system which may be used as part of or in association with a system such as that of FIG. 9. FIG. 8 illustrates an embodiment of a device which may be used as part of a system or network.

The overall system in which a note operates may further be understood with reference to the type of entities using the note. FIG. 9 illustrates a system in which a note may be used. A central bank 910 provisions notes and provides them to consumer banks 930. An issuing authority 920 such as a mint, treasury, or bureau of engraving, may be involved as well. Collectively, the central bank 910 and issuing authority 920 may be expected to provide funds recorded in a blockchain transfer such as a bitcoin transaction to back the value of a note. These funds may be in bitcoin, for example, or another blockchain-based currency, for example. Consumer banks 930 provide the notes in circulation to consumers 940 and merchants 950, which collectively exchange the notes in commerce. This may or may not require exhausting the note in any given transaction, but allows for checking the note against blockchain transactions as part of the circulation process.

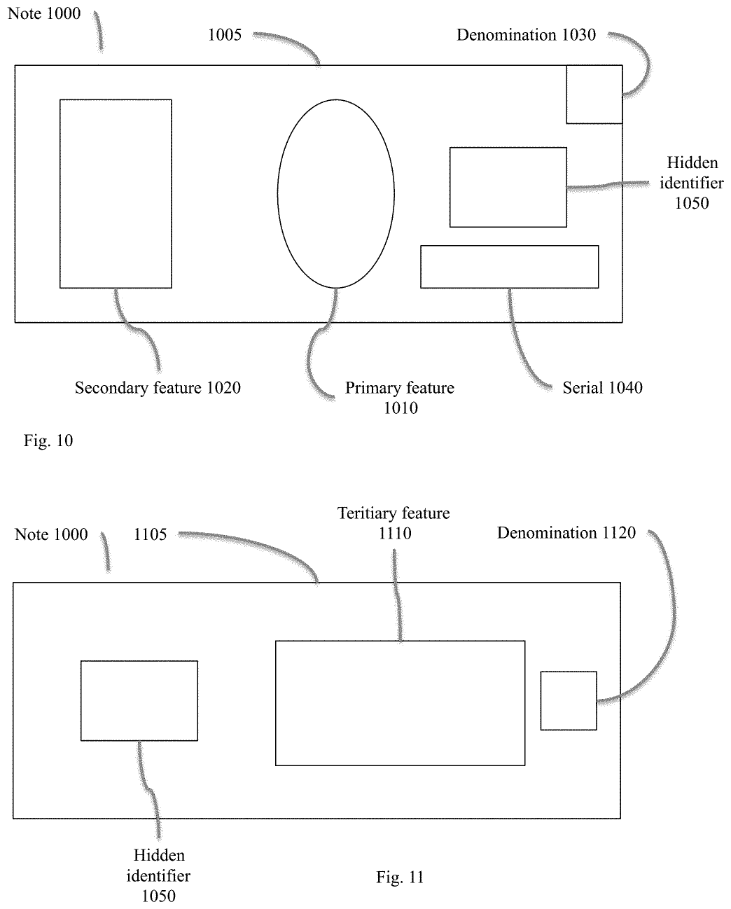

Notes of various kinds can be used with the processes described above, provided the notes include some form of hidden identifier which can be matched with a serial number in a cryptocurrency transaction. FIG. 10 illustrates an embodiment of a note in a front view. Note or bill 1000 includes features for identifying the type of bill, features for identifying the validity of the bill, and a denomination. For example, primary feature 1010 is provided and may be a portrait or a picture of a location in an embodiment. Additionally, secondary feature 1020 is provided and may be a watermark or other feature which corresponds to primary feature 1010, and may typically have a pictorial nature as well. These features provide a visual indication of the type of note used. Denomination 1030 provides an indication of the stored value of a note. Denomination 1030 may or may not ultimately correspond to the actual value of the note 1000, depending on usage of the note 1000. Each of these features, 1010, 1020 and 1030 are provided on a front surface 1005 of the note, or are observable on the front surface 1005 of the note.

Note 1000 may be made of typical materials such as cotton or linen thread woven to form note 1000, for example, some form of paper, or some other material such as a durable plastic. Note 1000 may also have embedded security features, such as a security strip, microprinting, holographic printed features, or other security features. Moreover, note 1000 may have other design elements provided for a range of purposes including aesthetic considerations and security features, for example. A signature of an official or a year of printing may be provided, for example.

Note 1000 also includes a serial number 1040, shown on front surface 1005. The serial number 1040 may be expected to be unique to a given instance or copy of the note 1000, although this may also be varied by the issuer of the note 1000. Note 1000 further includes hidden identifier 1050. Hidden identifier 1050 includes a cover material and a backing material, and may include a further overlay or additional material adhered to note 1000 in some instances. Hidden identifier 1050 is shown as visible on the front surface 1005 of note 1000, but it may also be visible from the back surface 1105 of note 1000, or both surfaces in some embodiments. Hidden identifier 1050 includes an identifier such as a unique QR (quick response) code, bar code, or other encoded format. The identifier of hidden identifier 1050 is recorded in conjunction with the serial number 1040 of note 1000 at the time of issuance, and the value of the note 1000 is stored on the note 1000 by virtue of the presence of hidden identifier 1050. At the time of issuance, or in conjunction therewith, the identifier of hidden identifier 1050 is recorded in a blockchain such as that of a cryptocurrency (e.g. Bitcoin or another cryptocurrency) or a blockchain chosen as authoritative by the issuer of the note 1000. Thus, the value of hidden identifier 1050 may be verified later by a third party. Hidden identifier 1050 is covered on both sides by opaque coverings to prevent misuse. The identifier of hidden identifier is either printed or otherwise provided on the surface of note 1000, or is applied, such as through an adhered surface to the surface of note 1000.

Considering the back surface of note 1000, FIG. 11 illustrates an embodiment of a note in a back view. Back surface 1105 is shown providing a tertiary factor 1110, such as an image which is associated with the note 1000. Denomination 1120 is also provided to identify the intended value of the note 1000. Moreover, the back side of hidden identifier 1050 is shown as illustrated. As with front surface 1005, back surface 1105 may include other features of various types. Moreover, both front surface 1005 and back surface 1105 may have information applied in various ways, such as printing, embossing, or otherwise applying information to the surfaces 1005 and 1105 of note 1000.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. A method of provisioning a note for use as currency, comprising:
receiving a base material;
printing a note from the base material, the note including a first unique identifier and a second unique identifier;
covering the second unique identifier with a tamper-proof material;
covering a back of the second unique identifier with a tamper-evident material;
and
associating the note with a predetermined amount of cryptocurrency.

2. The method of claim 1, wherein
associating the note with a predetermined amount of cryptocurrency includes
recording a transaction associating the first unique identifier and the second unique identifier with the predetermined amount of cryptocurrency in a recordation facility accessible for validation of the cryptocurrency.

3. The method of claim 1, wherein:
printing the note includes printing a microprinted feature.

4. The method of claim 1, wherein:
printing the note includes printing a hologram feature.

5. The method of claim 1, wherein:
printing the note includes printing a denomination.

6. The method of claim 1, wherein:
printing the note includes printing an issuing authority identifier.

7. The method of claim 1, wherein:
printing the note includes printing a year of issuance.

8. The method of claim 1, wherein:
printing the note includes printing a watermark.

9. The method of claim 1, wherein:
printing the note includes printing a portrait.

10. The method of claim 1, wherein:
printing the note includes printing an image.

11. The method of claim 1, wherein:
printing the note includes printing a background illustration.

12. (canceled)

13. (canceled)

14. The method of claim 1, wherein:
printing the note includes incorporating a first security feature.

15. The method of claim 14, wherein:
printing the note includes incorporating a second security feature.

16. The method of claim 1, wherein:
incorporating the first security feature includes embedding a security thread in the note.

17. The method of claim 2, wherein:
the cryptocurrency is Bitcoin.

18. The method of claim 2, wherein:
the cryptocurrency is a cryptocurrency issued by a central bank.

19. A method of provisioning a note for use as currency, comprising:
receiving a base material;
printing a note from the base material, the note including a first unique identifier and a second unique identifier;
covering the second unique identifier with a tamper-proof material;
covering a back of the second unique identifier with a tamper-evident material;
and
recording a transaction associating the first unique identifier and the second unique identifier with the predetermined amount of cryptocurrency in a recordation facility accessible for validation of the cryptocurrency.

20. The method of claim 19, wherein:
printing the note includes printing a denomination, an issuing authority identifier, printing a year of issuance and printing a watermark.

21. The method of claim 20, wherein:
printing the note includes incorporating a first security feature and a second security feature.

22. A method of provisioning a note for use as currency, comprising:
receiving a base material;
printing a note from the base material, the note including a unique identifier;
and
backing the note with a predetermined amount of a cryptocurrency in association with the unique identifier.

23. (canceled)
